(19) United States
(12) Patent Application Publication
(10) Pub. No.: US 2002/0085535 A1
(43) Pub. Date: Jul. 4, 2002

(54) System for enhancing internet telephony

(76) Inventor: Donald A. Williams, The Woodlands, TX (US)

Correspondence Address: TELECONOMICO USA INC., 26009 BUDDE ROAD, SUITES B-200/B-300, THE WOODLANDS, TX, 77380, US

(21) Appl. No.: 09/750,203

(22) Filed: Dec. 28, 2000

(51) Int. Cl. H04L 12/66

(52) U.S. Cl. 370/352; 370/401; 370/466

(57) ABSTRACT

In one embodiment the invention comprises a method of communication utilizing the Internet which includes receiving on a server an e-mail message transmitted from a first computer, which email includes a request to the intended recipient of the e-mail for a return telephone call to a telephone number designated in the e-mail, and including in the e-mail transmission the address of a gatekeeper for providing the address of a gateway through which a telephone call originated on a computer of the intended e-mail recipient may be routed to the public switched telephone network and to the telephone number designated in the e-mail.

### BACKGROUND OF THE INVENTION

1. Field of the Invention

This invention is related to the general subject of Internet communications and in particular to voice communications over the Internet.

2. Description of Related Art

The Internet originated from U.S. Government funded research which made possible a national internetworked communication system. This work resulted in the development of a set of conventions (protocols) for interconnecting networks and routing information. These protocols are generally referred to as TCP/IP (Transmission Control Protocol/Internet Protocol). The Internet basically comprises several large computer networks joined together over high speed data links.

A simplified diagram of the Internet is shown in FIG. 1. The Internet comprises Autonomous Systems (ASs), which may be operated by Internet Service Providers (ISPs), such as PDQ and America On Line (AOL). FIG. 1 shows three AS/ISPs, designated by numerals 10, 12 and 14. The Autonomous Systems are linked together by communication links 11, 13 and 15, which may be fiber optic links. The Internet also includes Information Providers, such as various governmental agencies and universities. FIG. 1 shows three Information Providers, designated by numerals 16, 18 and 24. The Information Providers are shown linked to the Internet by communication links 20, 22 and 26, which may be fiber optic communication links.

Corporate Local Area Networks (LANs), such as those illustrated in 28 and 30, are connected through routers 32 and 34 and communication links 36 and 38. Laptop computers 40 and 42, representative of computers connected to the Internet via the public switched telephone network (PSTN), are shown connected to the AS/ISPs via dial up links 44 and 46.

The Information Providers collect and market information through their own servers. Internet Service Providers, which market the usage of their networks, transport the information from the Information Providers to the user who requests the information.

The Internet may be viewed as a series of routers connected together, and with computers connected to the routers. In the addressing scheme of the Internet an address comprises a set of four numbers separated by dots. An example would be 164.947.483.492. Each machine on the Internet has a unique address which constitutes one of these four number sets. The leftmost number in the address is the highest order number, and is generally referred to as the first number. Typically, the first two numbers will indicate a network or a location. When the packet bearing the destination address leaves the source router it compares the first two numbers with a matrix table to determine how many hops are the minimum to get to the destination. Each router has a data base table that finds the information automatically. The router then sends the packet to the next router determined from that table and the procedure is repeated. This continues at each router along the transmission path until the packet arrives at the destination computer. The next number field, number 483 in the example shown, identifies the destination router. The last number identifies the specific computer in the destination network. That network is connected to the last router in the transport path. In differentiating between two computers in the same destination network only the last number field changes. The separate packets that constitute a message may not travel the same path across the Internet, because of variations in the Internet traffic load. However, the data packets all reach the same destination and are assembled in their original order in a connectionless fashion.

One of the more frequently used services available on the Internet is electronic mail, or e-mail. Initially, e-mail software only allowed a person using one computer to type a message and send it across the Internet to a person using another computer. However, current e-mail systems can be used to send a single message to many recipients, send a message that includes text, audio, video, or graphics, send a message to a user on a network outside the Internet, or send a message to which a computer program responds.

Computer communication always involves interaction between two programs called a client and a server. E-mail systems follow the client-server approach: two programs cooperate to transfer an e-mail message from the sender's computer to the recipient's mailbox (transfer requires two programs because an application running on one computer cannot store data directly in a mailbox on another computer's disk). When a user sends an e-mail message, a program on the sender's computer becomes a client. It contacts an e-mail server program on the recipient's computer and transfers a copy of the message. The server stores the message in the recipient's mailbox. The interaction between a client and server is complex because at any time computers or the Internet connecting them can fail (e.g., someone can accidently turn off one of the computers). To ensure that e-mail will be delivered reliably, the client keeps a copy of the message during the transfer. After the server informs the client that the message has been received and stored on disk, the client may erase its copy.

To receive electronic mail, a user must have a mailbox, identified by a unique address, which resides on a computer which runs e-mail software, and a storage area, usually on a disk, that holds incoming e-mail messages until the user has time to read them. When a message arrives, e-mail software automatically stores it in the user's mailbox.

To send electronic mail across the Internet, an individual runs an e-mail application program on their local computer. The local application program operates similar to a word processor—it allows a user to compose and edit a message and to specify a recipient by giving a mailbox address. Once the user finishes entering the message and adds attachments, e-mail software sends it across the Internet to the recipients's mailbox.

When an incoming e-mail message arrives, system software is configured to inform the recipient by displaying text or a graphic symbol on the user's display or by other means. Once e-mail has arrived, a user can extract messages from the user's mailbox using an application program. The application program allows a user to view each message. After viewing a message, a user can send a reply to whoever sent the message, leave the message in the mailbox so it can be viewed again, save a copy of the message in a file, or discard the message.

A computer cannot receive e-mail unless it has a e-mail server program running. On large computers, the system administrator arranges to start the server when the system first begins, and leaves the server running at all times. The server waits for an e-mail message to arrive, stores the message in the appropriate mailbox on disk, and then waits for the next message. However, a user who has a personal computer that is frequently powered down or disconnected from the Internet cannot receive e-mail while the computer is inactive. Therefore, most personal computers do not receive e-mail directly. Instead, a user arranges to have a mailbox on a large computer with a server that always remains ready to accept an e-mail message and store it in the user's mailbox. For example, users can choose to place their mailbox on their company's main computer, even if they used a personal computer for most work. To read e-mail from a personal computer, a user must contact the main computer system and obtain a copy of their mailbox.

One or more companies have recently developed software for use on personal computers to permit two-way transfer of real-time voice information via an Internet data link between two personal computers. In one of the directions the sending computer converts voice signals from analog to digital format. The software facilitates data compression down to a rate compatible with modem communication via a POTS telephone line. The software also facilitates encapsulation of the digitized and compressed voice data into the TCP/IP protocol with appropriate addressing to permit communication via the Internet. At the receiving end, the computer and software reverse the process to recover the analog voice information for presentation to the other party. Such programs permit telephone-like communication between Internet users registered with Internet Phone Servers.

A need continues to exist, however, for enhanced use of the Internet to further facilitate communications.

It should be noted that the description of the invention which follows should not be construed as limiting the invention to the examples and preferred embodiments shown and described. Those skilled in the art to which this invention pertains will be able to devise variations of this invention within the scope of the appended claims.

### SUMMARY OF THE INVENTION

The invention is a method for enhancing the use of the Internet which includes installing software into an Internet connection device to enable the connection device to add a link to an e-mail message requesting an e-mail recipient to place a return telephone call, in which the link includes information to enable the e-mail receiver to download a computer program into the e-mail recipient's computer to facilitate the placing of a telephone call from the e-mail recipient's computer to a telephone.

In another embodiment the invention comprises a method of communication utilizing the Internet which includes receiving on a server an e-mail message transmitted from a first computer, which email includes a request to the intended recipient of the e-mail for a return telephone call to a telephone number designated in the e-mail, and including in the e-mail transmission the address of a gatekeeper for providing the address of a gateway through which a telephone call originated on a computer of the intended e-mail recipient may be routed to the public switched telephone network and to the telephone number designated in the e-mail.

### BRIEF DESCRIPTION OF THE DRAWINGS

FIG. 1 illustrates the background of the invention.

FIG. 2 shows a preferred implementation of the invention.

FIG. 3 shows a display screen useful for composing an e-mail according utilizing the present invention.

FIG. 4 shows a display screen of an e-mail recipient utilizing the present invention.

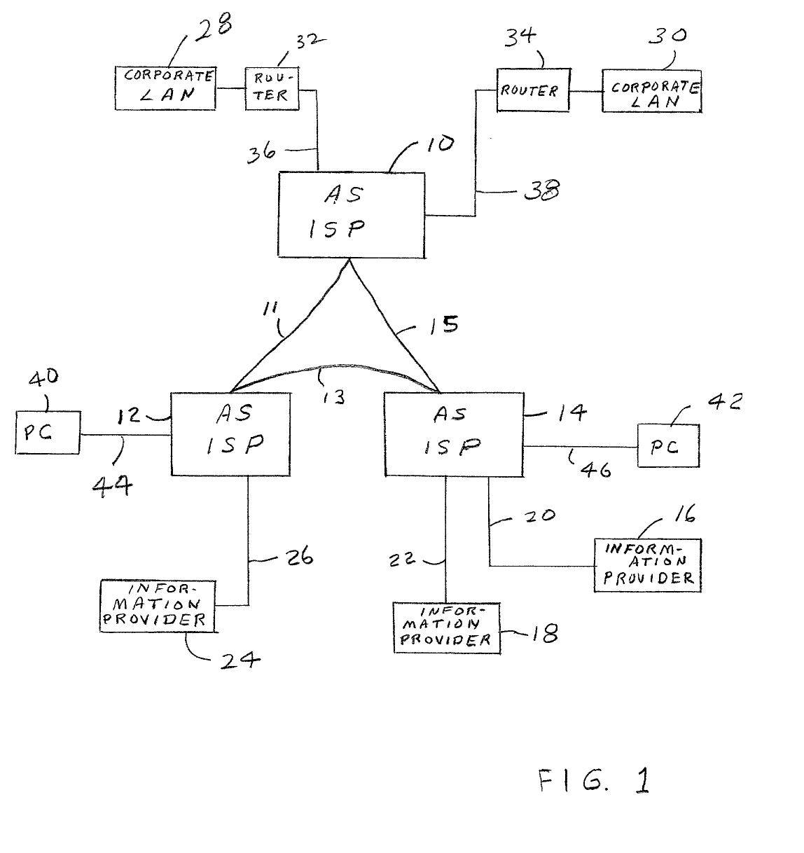

### DESCRIPTION OF PREFERRED EMBODIMENTS

In accordance with the present invention, normal e-mail service is enhanced to enable a user of the e-mail service to include a feature in an e-mail which requests the e-mail recipient to replace a return telephone call over the Internet. In one embodiment, a “button” is included in an e-mail which alerts the e-mail recipient that the sender of the e-mail desires a return telephone call and which enables the e-mail recipient to place the telephone call over the Internet by pressing, or “clicking on”, the button. The return telephone call is routed from the Internet to a telephone, which may be a standard telephone or a cellular telephone. The “button” or equivalent feature may also be included in the “Subject” line which identifies the e-mail, such that clicking on the e-mail message results in the placement of the return telephone call

It is contemplated that a service utilizing the present invention may be offered as an enhancement to more standard e-mail services, and that an e-mail service provider will offer such service to an e-mail user pursuant to a contract or other arrangement for providing e-mail services.

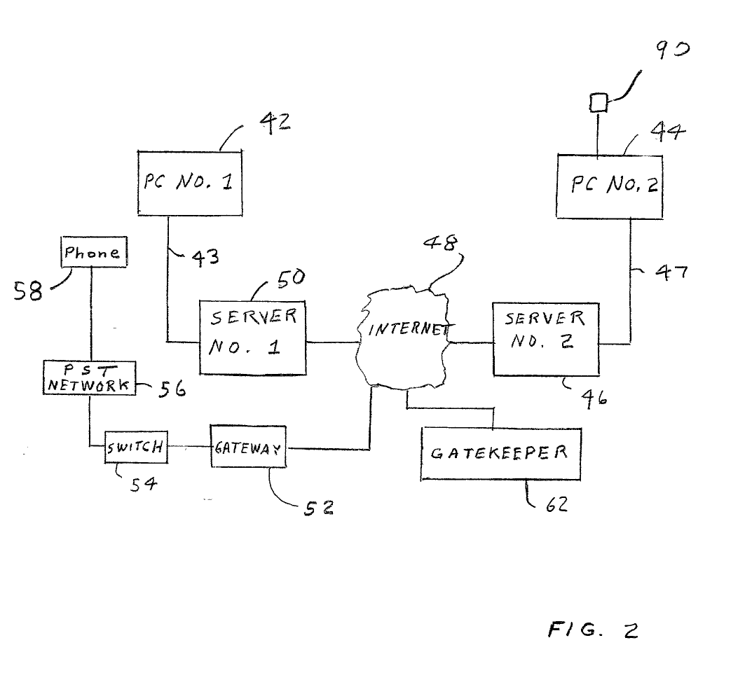

The software which operates an e-mail service typically resides on a server, such as the Server No. 1, designated by numeral 50 in FIG. 2. To send and receive e-mail across the Internet, an individual will run an e-mail application program on the individual's local computer, such as the personal computer, PC No. 1, designated by numeral 42 in FIG. 2. In order to implement the present invention appropriate computer code (the “Enhancement Code”) is included in an e-mail application program on an individual's local computer. This Enhancement Code will normally be supplied by the e-mail service provider and either included with the initial e-mail application program installed on the local computer, or supplied by the e-mail service provider over the Internet and downloaded by the user. Those of ordinary skill in the art will understand how to write such Enhancement Code based on the description of the invention herein, and the code will not be discussed in detail herein.

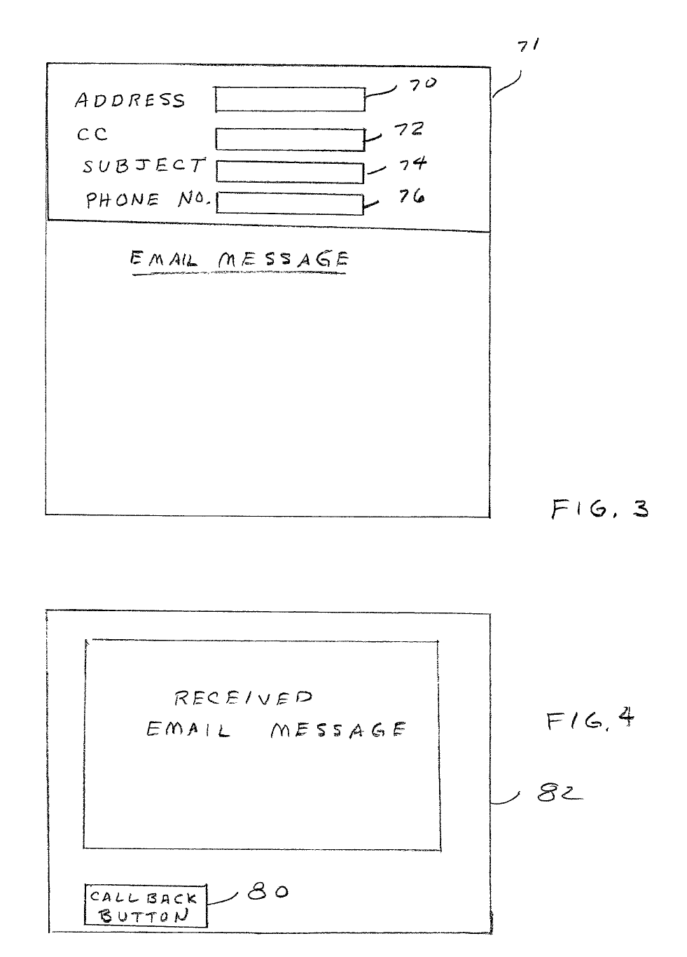

To enable the user to compose an e-mail, the e-mail application program will typically display a button, such as a button that displays “WRITE” or some other verbal or graphic indication, that enables the user to compose an e-mail message when the button is clicked on. Typically, the computer display screen will display a format which indicates to the user the locations for inserting the information needed to complete the e-mail. FIG. 3 shown such a display 71, which includes location 70 for inserting the intended recipient's e-mail address, location 72 for inserting any additional e-mail addresses to which the e-mail user desires the message to be sent, location 74 for including a subject description for an e-mail message, and, in accordance with the present invention, a location 76 where the e-mail user may insert the telephone number to which the e-mail user desires the e-mail recipient to place a return telephone call. The e-mail application program may also provide for the e-mail user to insert a telephone number in this space by clicking on an entry in a personal phone book the user has stored in computer memory. Insertion of a telephone number in the location 76 causes the e-mail message to include a hyperlink along with the transmitted e-mail which will cause an indication, which may be in the form of a graphic, to be placed on the display screen of the recipient of the e-mail. This graphic may be in the form of a button which conveys a verbal or graphical indication to the e-mail recipient that the sender of the e-mail desires the e-mail recipient to place a return telephone call. FIG. 4 shows a typical representation 82 of the e-mail as displayed on the recipient's display, with the “call back” button indicated by numeral 80. It is understood that this indication may also be included in the Subject line of the e-mail message.

As shown in FIG. 2, the e-mail message is transmitted from the e-mail sender's PC 42 over communications link 43, which may be a dial up telephone link, or a cable or fiber optic link, to server 50, on which the e-mail service provider's software resides. From server 50, the e-mail message is transmitted over the Internet 48 and reaches the server 46, on which the software resides for the e-mail service provider that furnishes e-mail service to PC No. 2, designated by numeral 44. The e-mail is then transmitted over communications link 47 to PC No. 2, the e-mail recipient's PC, which is designated by numeral 44.

As previously stated, the sender of the e-mail message will insert the telephone number at which the sender desires to receive a return telephone call. The software which operates the e-mail service and which resides on Server No. 1 will include authentication information about the e-mail user sending the message (such as the user's identification number). The software which operates the e-mail service will also look up, in a look-up table, the Internet address of a gatekeeper with which the computer of the e-mail recipient may communicate to confirm the authentication information. This software will also insert information in the e-mail to enable the browser of the computer receiving the e-mail message to download appropriate software to enable the e-mail recipient to generate a return telephone call.

In a preferred embodiment, a return telephone call is generated by clicking on the graphic, or call back button, 80, which has been placed on the e-mail recipient's display. To enable the initiation of the return telephone call, appropriate software needs to be installed on the e-mail recipient's computer. When the e-mail recipient clicks on the call back button to initiate the return telephone call, the hyperlink associated with the call back button will cause the browser program installed on the computer to search for the software which generates the return telephone call. If the software is not found, the browser may display a message on the computer monitor screen which will ask if the e-mail recipient desires to have the appropriate software downloaded. If the e-mail recipient responds in the affirmative, by clicking on the designated graphic or otherwise, the browser will typically transmit a request over the Internet to a server on which appropriate software resides. It is understood that various hardware and/or software system configurations may be utilized for implementing the present invention, and that the downloaded software will need to compatible with the system configuration An example of the software that may be utilized is a Java based telephony applet, available free of charge from Vocaltec USA, Inc. Those of ordinary skill in the art will understand how to write such software, and such software will not be described in detail herein.

Once the Java based telephony applet from Vocaltec USA, Inc., or other appropriate software, is installed on the e-mail recipient's computer, the return call may be generated by clicking on the call back button 80, which opens a browser window. The data included with the hyperlink will include the telephone number to be called and the address of a telephony gatekeeper. A inquiry is then transmitted over the Internet to the designated gatekeeper, which may be gatekeeper 62, as shown in FIG. 2, to confirm the authentication information supplied in the e-mail. The gatekeeper accesses a data base (not shown) to obtain such confirmation, and upon such confirmation, the gatekeeper will supply the address of a gateway (for example, gateway 52) to which the return telephone call may be transmitted, which will couple the telephone call from the Internet to the PSTN (public switched telephone network). The telephony applet will then establish communication with the designated gateway and initiate the telephoning process. During the telephone call, the e-mail recipient will speak into microphone 90 which converts the sound of the speaker's voice into an analog electrical signal which is applied to electronic circuitry in the computer in a manner well known to those of ordinary skill in the art

When the e-mail recipient initiates the return telephone call, an e-mail message may be transmitted over the Internet to the originating party's computer to confirm that the call has been placed. In one implementation of the invention, the gatekeeper will record the transaction and will not authorize additional calls based on the same call back request from the user.

With reference to FIG. 2, once the communications link is established between the e-mail recipient's computer 44 and the telephone 58, the voice of the e-mail recipient is digitally encoded at the e-mail recipient's computer and is transmitted over transmission link 47. When the digitized voice message reaches the server 46 it is broken into packets in the normal manner for an Internet transmission and transmitted over the Internet to the gateway address supplied by the gatekeeper, as described above. This gateway is shown in FIG. 2 as gateway 52. Gateway 52 reassembles the packets into the order in which they were originated and converts the digital signal into an analog voice signal in the form which is normally transmitted over the Public Switched Telephone Network. This voice analog is then transmitted to switch 54 (a switch which is similar to switches employed in the PSTN) which connects the signal into the PST Network 56 through which the call is routed to telephone 58.

In a preferred embodiment the placing of the return call is also facilitated because the charge for the return call is assigned to the sender of the e-mail. In one implementation a service provided in accordance with the invention described herein may be provided as a part of a paid subscription service. Services utilizing the invention described herein may also be provided to a user without cost, through a service supported by advertising.

It will be appreciated that various modifications, alternatives, variations, and changes may be made without departing from the scope of the invention as defined in the appended claims. It is intended to cover by the appended claims all such modifications involved within the scope of the claims.

I claim:

1. A method for enhancing the use of the Internet, comprising:
installing software into an Internet connection device to enable said connection device to add a link to an e-mail message requesting a recipient of the e-mail to place a telephone call to a designated telephone number; and
wherein said link includes information to enable the e-mail recipient to download a computer program into the e-mail recipient's computer to facilitate the placing of said telephone call from the e-mail recipient's computer.

2. The method of claim 1 wherein said Internet connection device is a personal computer.

3. A method of communication utilizing the Internet, comprising:
receiving on a server an e-mail message transmitted from a first computer, which e-mail message includes a request to an intended recipient of the e-mail for a return telephone call to a telephone number designated in the e-mail;
transmitting said e-mail message to a second computer specified in an address associated with said e-mail message, and including in said e-mail transmission the address of a gatekeeper, said gatekeeper adapted to supply an address of a gateway through which a telephone call originated on said second computer may be routed to said telephone number designated in said e-mail message.

4. The method of claim 3 wherein said gatekeeper is further adapted to confirm authentication information supplied in the e-mail about the e-mail user sending the e-mail.

5. A method of providing communications, comprising:
receiving on a first server an e-mail transmission from a first Internet connection device originated by a first e-mail user, said e-mail transmission including a link which when displayed on a second Internet connection device enables a second e-mail user of said second Internet connection device to initiate voice communication between said second Internet connection device and a telephone number specified in said link;
transmitting said e-mail message from said first server to an address of said second Internet connection device; and
generating a telephone call from said second Internet connecting device to said telephone number.

6. The method of claim 5 wherein said second Internet connection device obtains from a gatekeeper the address of a gateway through which said telephone call my be connected to said telephone number.

7. The method of claim 5 wherein said first Internet connection device is a personal computer.

8. The method of claim 5 wherein said second Internet connection device is a personal computer.
